(19) United States
(12) Patent Application Publication
(10) Pub. No.: US 2026/0230231 A1
(43) Pub. Date: Aug. 6, 2026

(54) HARQ SUB-CODEBOOK GENERATION

(71) Applicant: InterDigital Patent Holdings, Inc., Wilmington, DE (US)

(72) Inventors: Aata El Hamss, Laval (CA); Tuong Hoang, Montreal (CA); Tao Deng, New York, NY (US); Moon IL Lee, Melville, NY (US)

(73) Assignee: InterDigital Patent Holdings, Inc., Wilmington, DE (US)

(21) Appl. No.: 19/149,330

(22) PCT Filed: Feb. 12, 2024
(86) PCT No.: PCT/US2024/015334

§ 371 Date: Jul. 18, 2025

Related U.S. Application Data
(60) Provisional application No. 63/445,317, filed on Feb. 14, 2023.

(51) Int. Cl. H04L 1/1812; H04L 1/1867

(52) U.S. Cl. CPC H04L 1/1812; H04L 1/1896

(57) ABSTRACT

A wireless transmit/receive unit (WTRU) may generate a first HARQ sub-codebook. The first HARQ sub-codebook may include HARQ feedback for one or more sidelink transmissions, for example according to a first HARQ mode. The WTRU may determine that a second HARQ mode is enabled, for example for the one or more sidelink transmissions. The WTRU may determine a size of a second HARQ sub-codebook. The second HARQ sub-codebook may include HARQ feedback for the one or more sidelink transmissions, for example according to the second HARQ mode. The WTRU may generate the second HARQ sub-codebook. The WTRU may transmit the first HARQ sub-codebook and/or the second HARQ sub-codebook, for example to a network.

### CROSS-REFERENCE TO RELATED APPLICATIONS

This application claims the benefit of U.S. Provisional Application No. 63/445,317 filed on Feb. 14, 2023, the entire contents of which are incorporated herein by reference.

### BACKGROUND

Unlicensed spectrum may include frequency resources that are free to use by different operators and possibly with different radio technologies. The transmitters may transmit on unlicensed spectrum if channel access succeeds (e.g., listen before talk (LBT) succeeds). When LBT fails, the transmitter may back off for a certain duration and attempt to access the channel at later occasion. The transmitter may keep trying until the channel is idle. This procedure may cause delays for transmission and add some uncertainty on when a transmission will successfully be delivered.

New radio (NR) sidelink may support two resource allocation modes, where in mode 1 the gNB is responsible for allocating resources for sidelink transmissions, and in mode 2 the transmitter wireless transmit/receive unit (WTRU) autonomously selects resources for sidelink transmissions. For mode 1, the WTRU may request resource(s) for sidelink data transmission using a Buffer Status Report (BSR) in a medium access control (MAC) control element (CE) indicating the logical channel groups (LCG) for the requested grant. The WTRU may then receive a downlink control information (DCI) scheduling sidelink grant from the gNB that indicates a physical uplink control channel (PUCCH) resource on which the WTRU may report the hybrid automatic repeat request (HARQ) status of the sidelink grant transmission. For mode 2, the WTRU may autonomously select resources for transmission using a sensing technique.

### SUMMARY

A WTRU may be configured to report one or more (e.g., two) HARQ sub-codebooks, where a first HARQ sub-codebook may carry 2-state HARQ feedback for one or more (e.g., all) the scheduled sidelink grants, and a second HARQ sub-codebook may carry additional information for (e.g., only) sidelink grants with 3-state HARQ enabled. The WTRU may determine, for a sidelink grant, whether to use 3-state HARQ-acknowledgment (ACK) or 2-state HARQ-ACK. The WTRU may determine the size of the first HARQ-ACK sub-codebook using legacy behavior.

The WTRU may determine the size of the second HARQ sub-codebook based on the number of sidelink grants configured with 3-state HARQ and the corresponding physical sidelink feedback channel (PSFCH) information received before the HARQ codebook transmission time. For a sidelink with 3-state HARQ, if the corresponding sidelink PSFCH indicates ACK is received from the receiver (Rx) WTRU before the transmission time of the HARQ codebook, the WTRU may not report any information in the second HARQ sub-codebook. If the corresponding sidelink PSFCH indicates non-acknowledgement (NACK) is received from the Rx WTRU before the transmission time of the HARQ codebook, the WTRU may report a value of 0 in the second HARQ sub-codebook. If the corresponding sidelink PSFCH is not received from the Rx WTRU before the transmission time of the HARQ codebook, the WTRU may report a value of 1 in the second HARQ sub-codebook. The order of the bits in the second HARQ sub-codebook may follow the order of the scheduled sidelink grants.

The WTRU may determine whether to report the two HARQ sub-codebooks in the same uplink resource or separate resources based on the gNB indication in the DCI. The WTRU may transmit the two HARQ sub-codebooks to the gNB. The WTRU may receive the sidelink HARQ feedback from the Rx WTRU after being delayed. The WTRU may be configured to report HARQ feedback for previously delayed HARQ feedback using a DCI that triggers the previously-delayed HARQ feedback; and/or by appending the delayed HARQ feedback to the HARQ codebook that will be transmitted after X ms from the initial transmission of the HARQ codebook.

The WTRU may report a group of sidelink HARQ feedback using one or more (e.g., two) HARQ sub-codebooks, where a first HARQ sub-codebook may compromise two-state HARQ for one or more (e.g., all) sidelink grants of the group and a second HARQ sub-codebook may comprise some sidelink grants from the group using 3-state HARQ.

A WTRU may receive configuration information. The configuration information may include at least one predefined value for at least one sidelink (SL) data characteristic. The WTRU may receive a sidelink (SL) grant assignment, for example from a network. The WTRU may transmit SL hybrid HARQ information in a first HARQ mode, for example based on the at least one predefined value for the at least one SL data characteristic being met for the SL grant assignment. The first HARQ mode may include acknowledgment/non-acknowledgement (ACK/NACK). The WTRU may transmit the SL HARQ information in a second HARQ mode, for example based on the at least one predefined value for the at least one SL data characteristic not being met for the SL grant assignment. The second HARQ mode may include a delayed HARQ. The first HARQ mode may include a 2-state HARQ mode and/or the second HARQ mode may include a 3-state HARQ mode.

The WTRU may determine whether to use the first HARQ mode and/or the second HARQ mode, for example based on the at least one predefined value for the at least one SL data characteristic being met for the SL grant assignment. The SL data characteristics may include at least one of a packet delay budget (PDB) value, a quality of service (QoS) value associated with a packet quality indicator (PQI), a supported logical channel, a supported slot, a physical sidelink feedback channel (PSFCH) location, a physical uplink (UL) control channel (PUCCH) transmission time, or an indication in a downlink control information (DCI). The SL HARQ information may include an indication of whether at least one SL resources are requested (e.g., by the WTRU).

The WTRU may generate at least one of a first HARQ sub-codebook for the first HARQ mode and/or a second HARQ sub-codebook for the second HARQ mode. The first HARQ sub-codebook may include the SL HARQ information and/or the second HARQ sub-codebook may include the SL HARQ information. The WTRU may determine to use the second HARQ mode and/or to add one bit to the second HARQ sub-codebook. The WTRU may determine to use the first HARQ mode and/or to add two bits to the first HARQ sub-codebook. The WTRU may receive a second SL grant assignment from the network, for example after at least one of adding the one bit to the second HARQ sub-codebook and/or adding the two bits to the first HARQ sub-codebook. The WTRU may determine whether to transmit at least one of the first HARQ sub-codebook and/or the second HARQ sub-codebook, for example based on a physical sidelink feedback channel (PSFCH) transmission.

The WTRU may generate a first HARQ sub-codebook. The first HARQ sub-codebook may include HARQ feedback for one or more sidelink transmissions, for example according to a first HARQ mode. The WTRU may determine that a second HARQ mode is enabled, for example for the one or more sidelink transmissions. The WTRU may determine a size of a second HARQ sub-codebook. The second HARQ sub-codebook may include HARQ feedback for the one or more sidelink transmissions, for example according to the second HARQ mode. The WTRU may generate the second HARQ sub-codebook. The WTRU may transmit the first HARQ sub-codebook and/or the second HARQ sub-codebook, for example to a network.

The first HARQ mode may include a 2-state HARQ mode and/or the second HARQ mode may include a 3-state HARQ mode. The 2-state HARQ mode may include acknowledgment/non-acknowledgement (ACK/NACK) and/or the 3-state HARQ mode may include a delayed HARQ. The WTRU may determine a number of the subset of the one or more sidelink transmissions for which a non-acknowledgement (NACK) has been received or no response has been received, for example when determining the size of the second HARQ sub-codebook. The WTRU may determine whether to transmit the first HARQ sub-codebook and the second HARQ sub-codebook in a same uplink (UL) resource or in different UL resources, for example based on an indication in a DCI. The WTRU may determine a size of the first HARQ sub-codebook. The WTRU may receive a PSFCH transmission, for example from another WTRU. The PSFCH transmission may include HARQ feedback. The WTRU may report the HARQ feedback, for example to the network. The WTRU may determine the size of the second HARQ sub-codebook based on a number of sidelink grants in the subset of the one or more sidelink transmissions. An order of bits included in the second HARQ sub-codebook may be based on an order of the number of sidelink grants in the subset of the one or more sidelink transmissions.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is an example flowchart indicating procedures to enable 3-state HARQ.

FIG. 3 illustrates an example of using two HARQ sub-codebooks.

FIG. 4 illustrates an example of a WTRU receiving a PSFCH after the transmission time of a first HARQ codebook.

FIG. 5 is an example flowchart indicating how a WTRU determines whether to transmit two HARQ sub-codebooks.

### DETAILED DESCRIPTION

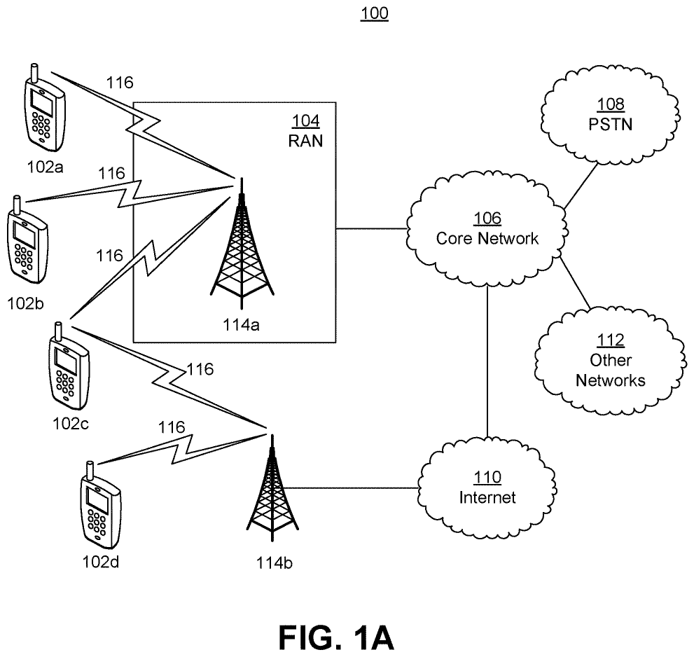

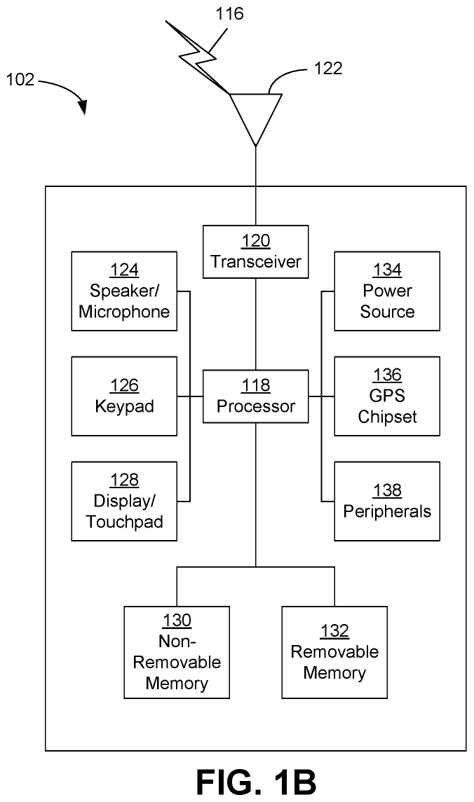

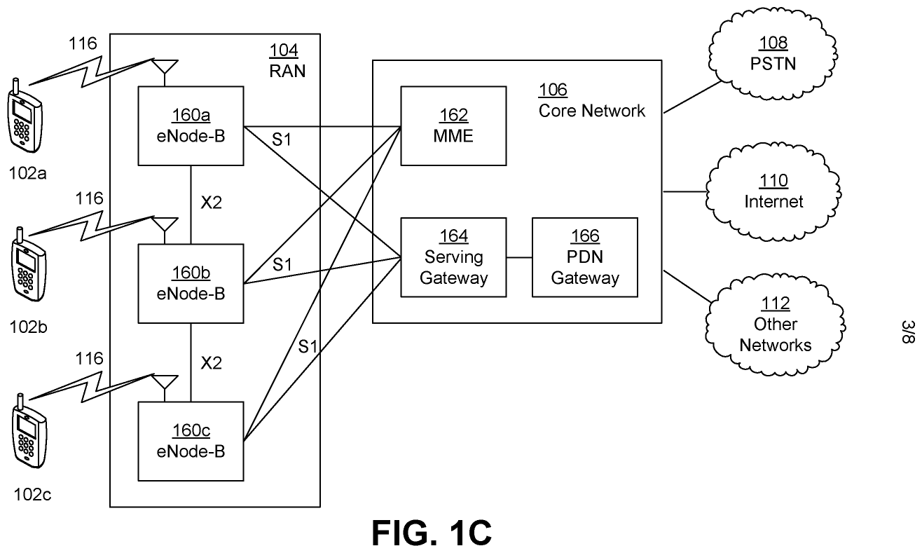

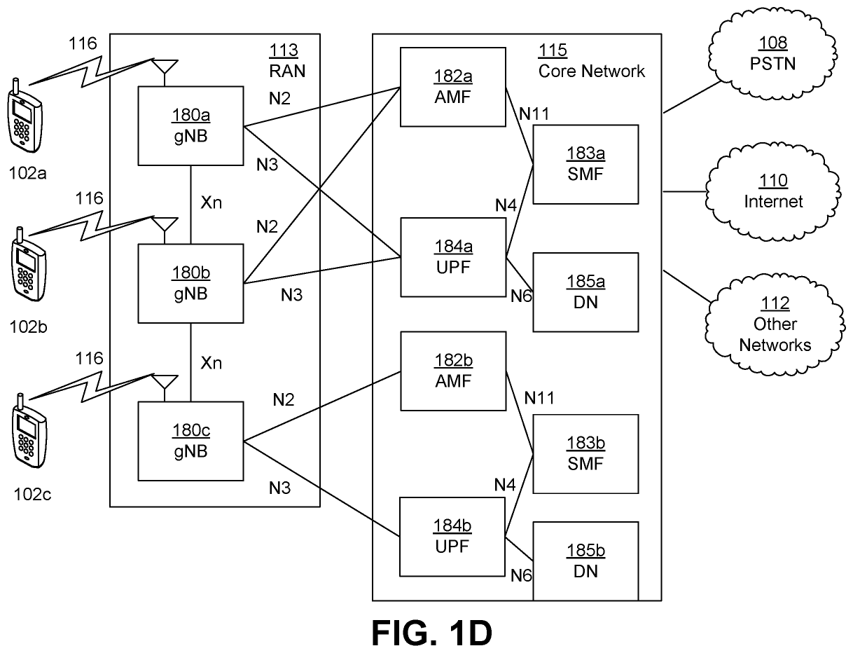

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A gNB may allocate resources for sidelink (SL). The gNB may be aware of the status of the transmission (e.g., acknowledgment (ACK) or negative acknowledgment (NACK)), for example when a gNB is allocating resources for sidelink, since the retransmission(s) may be scheduled by the gNB if needed. A WTRU may transmit SL hybrid automatic repeat request (HARQ) to the gNB. For example, a transmitter (Tx) WTRU may use a physical uplink control channel (PUCCH) to transmit the SL HARQ information to the gNB. SL HARQ information may include an indication of whether one or more SL resources are requested. SL HARQ information may additionally, or alternatively, include an indication of the one or more SL resources.

SL HARQ-ACK may not be transmitted by a receiver WTRU (e.g., with NR sidelink deployed in unlicensed spectrum), for example if listen before talk (LBT) fails and/or if channel occupancy time (COT) sharing is not used to transmit sidelink HARQ-ACK feedback to the transmitter WTRU. There may be an issue on what to transmit to the gNB as SL HARQ feedback on PUCCH, for example if the sidelink HARQ-ACK by the transmitter WTRU is not received. HARQ feedback may be delayed, for example to solve these issues. For example, HARQ feedback may be delayed in an unlicensed channel.

A third state of HARQ feedback may be supported. The third state of HARQ feedback may include a delayed HARQ feedback value. The transmitter WTRU may report a delayed HARQ feedback value to the gNB, for example if the sidelink HARQ feedback is not received by the transmitter WTRU. The gNB may wait for the SL HARQ feedback at later occasion, for example without assuming ACK and/or NACK. The transmitter WTRU may report the SL-HARQ feedback to the gNB, for example when available.

A sidelink grant may not tolerate an additional delay for retransmission. Waiting for delayed HARQ feedback to request additional resources for sidelink data transmission may not be tolerated, for example if the required latency to transmit sidelink data is small. 2-state HARQ may include ACK and/or NACK, for example reported to the gNB. A third state of HARQ may increase the uplink control signaling overhead, for example since more than one bit may be reported. The HARQ codebook size may increase. For example, HARQ codebook size may double if 2 bits of feedback are reported per each sidelink grant. When to enable the report of delayed HARQ value may be disclosed herein, for example such that feedback may be transmitted efficiently with reduced uplink overhead.

A Tx WTRU may report sidelink HARQ feedback to a gNB. The WTRU may report SL HARQ to indicate whether additional sidelink resources are desired (e.g., needed or not). A delayed HARQ value may be included in a message. The message may indicate that conventional HARQ feedback (e.g., ACK or NACK) is not available for transmission. For example, the message may be a message separate from conventional HARQ feedback. Three values may supported by a WTRU that supports reporting a delayed HARQ value. The three values may include an ACK value, a NACK value, and/or a delayed HARQ value. An ACK value may indicate successful decoding of a transmission and/or may indicate that the WTRU is in an ACK state. A NACK value may indicate unsuccessful decoding of a transmission and/or may indicate that the WTRU is in a NACK state. A delayed HARQ value may indicate that more time is needed to report ACK and/or NACK, and/or may indicate that the WTRU is in a delayed HARQ state.

A sidelink Tx WTRU may transmit data in sidelink channels, for example with sidelink HARQ feedback enabled. The Tx WTRU may (e.g., expect to) receive sidelink HARQ feedback from a receiver (Rx) WTRU. The Tx WTRU may report an ACK value to the gNB, for example if the Tx WTRU receives an ACK from the Rx WTRU. The Tx WTRU may report a NACK value, for example if the Tx WTRU receives a NACK from the Rx WTRU. The Tx WTRU may determine (e.g., assume) that the sidelink HARQ feedback is delayed and/or report the delayed HARQ value to the gNB, for example if sidelink HARQ feedback is enabled for sidelink data transmission and/or the sidelink HARQ feedback is not received from the Rx WTRU. The WTRU may determine (e.g., assume) that the sidelink HARQ feedback is delayed if the Tx WTRU does not receive a sidelink HARQ feedback before the PUCCH transmission time. For example, the WTRU may be configured with a time duration. The time duration may precede the PUCCH transmission time, for example for which the WTRU may determine (e.g., assume) that the sidelink HARQ feedback is delayed.

Sidelink HARQ feedback may be reported to the gNB, for example for a (e.g., each) HARQ feedback corresponding to sidelink grant transmission. The SL HARQ feedback may include one or more of an ACK/NACK value. Additionally, or alternatively, a delayed HARQ value may be reported. The WTRU may determine to report (e.g., be expected to report at later occasion) an ACK or NACK value, for example if the WTRU reports the delayed HARQ value to the gNB. A sidelink channel may be deployed in unlicensed spectrum. Additionally, or alternatively, a sidelink channel may be deployed in licensed spectrum.

One or more of the following terms may be used herein. “ACK state” may refer to a case where an ACK value is reported. “NACK state” may refer to the case where a NACK value is reported. “Delayed HARQ state” may refer to the case where a delayed HARQ value is reported. “HARQ feedback” may refer to an ACK value, a NACK value, and/or a delayed HARQ value. “HARQ feedback” may refer to multiple HARQ feedbacks. “2-state HARQ” (e.g., “2 states HARQ”) may refer to the case where (e.g., only) ACK/NACK values may be reported. “3-state HARQ” (e.g., “3 states HARQ”) may refer to the case where ACK/NACK/delayed HARQ values may be reported. “HARQ mode” may refer to whether the WTRU is using 2-state HARQ or 3-state HARQ for a sidelink grant. Sidelink grant using 3-state HARQ may refer to the case where 3-state HARQ is enabled for the sidelink grant. A HARQ codebook may include a set of bits that indicates HARQ feedback for a group of sidelink grants.

A delayed HARQ state may be enabled. Cell support for delayed HARQ reporting may be disclosed herein. A WTRU may be configured to determine whether a serving cell supports reporting delayed HARQ values to the gNB, for example as feedback for one or more (e.g., some) sidelink transmissions. The WTRU may receive one or more of RRC signalling, SIB, and/or MIB signalling, which for example may indicate whether the serving cell supports delayed HARQ values. The WTRU may determine whether 3-state HARQ is supported or not for a (e.g., each) sidelink transmission, for example if the cell supports delayed HARQ values. The WTRU may receive an RRC configuration. The RRC configuration may indicate that the cell supports reporting delayed HARQ values. The WTRU may determine whether to use sidelink grant 2-state HARQ and/or 3-state HARQ when reporting the sidelink feedback to the gNB. The WTRU may receive an RRC configuration that may indicate the cell does not support the report of 3-state HARQ, for example for a sidelink HARQ feedback report. The WTRU may then (e.g., always) report 2-state HARQ to the gNB for sidelink data transmission. The WTRU may receive a configuration. The configuration may include an indication of whether a (e.g., neighbouring) cell supports reporting delayed HARQ values to the gNB, for example as feedback for some sidelink transmissions. The serving cell may indicate to the WTRU whether the neighbouring cell supports 3-state HARQ or not, for example during handover.

Sidelink data characteristics configured with 3-state HARQ may be disclosed herein. The WTRU may be configured to use 3-state HARQ for sidelink data transmission that, for example may have (e.g., some specific) packet delay budget (PDB) values. The WTRU may be configured with a set of PDB values, for example for which the corresponding data transmission may use 3-state HARQ. For example, the WTRU may be configured to use 3-state HARQ for data transmission with PDB values greater than a PDB threshold. For a sidelink data transmission with PDB less than the threshold for example, 2-state HARQ may be used. For sidelink data transmission with PDB greater than the threshold for example, 3-state HARQ may be used. A data transmission with a large delay budget may tolerate additional delay to receive the feedback in some examples. Transmission with a small delay budget may not tolerate additional delays in some examples.

The WTRU may be configured to use 3-state HARQ for a sidelink data transmission. The SL data transmission may have specific QoS characteristics. The WTRU may be configured with a set of QoS flows, for example for which the corresponding data transmission may use 3-state HARQ. For example, the WTRU may be configured to use 3-state HARQ for data transmission with a QoS flow identifier within a pre-configured set of one or more values. 2-state HARQ may be used, for example for a sidelink data transmission with a QoS flow identifier that does not belong to the pre-configured set. The sidelink data transmission may (e.g., otherwise) use 3-state HARQ. The WTRU may be configured with sidelink radio bearers. The sidelink data transmission may use 3-state HARQ on the SL radio bearers.

The WTRU may be configured to use 3-state HARQ for sidelink data transmission, for example within some specific logical channels (LCHs) and/or logical channel groups (LCGs). The WTRU may be configured with a set of logical channels and/or logical channel groups for which the corresponding data transmission may use 3-state HARQ. For example, the WTRU may be configured to use 3-state HARQ for data transmission with an LCG identifier (ID) within a pre-configured set of one or more values.

The WTRU may be configured with slots for sidelink data, for example within a channel occupancy time (COT) structure for which 3-state HARQ may be used. For example, the WTRU may be configured with a last slot within a COT structure for which sidelink transmission may use 3-state HARQ. The WTRU may select a COT structure and/or report the COT structure to the gNB, and/or the gNB may configure the WTRU with a COT structure to be used for sidelink transmission. The WTRU may receive the configuration of the set of slots within a COT structure that may use 3-state HARQ. The configuration may be received while receiving COT structure configuration/sidelink grant allocation and/or may be fixed in the specification. For example, the channel occupancy time (COT) may use 3-state HARQ. A slot (e.g., the last slot) of a COT may use 3-state HARQ.

A WTRU may determine whether to use 3-state HARQ for a scheduled sidelink grant. 2-state HARQ may include ACK and/or NACK, for example reported to the gNB. 3-state HARQ may include ACK, NACK and one or more delayed HARQ values. The WTRU may be configured to determine whether to use 3-state HARQ or 2-state HARQ for a (e.g., each) scheduled sidelink grant. 3 HARQ feedback values may be reported to the gNB (e.g., ACK and/or NACK and/or delayed HARQ), for example if the WTRU determines that 3-state HARQ is to be used for a sidelink data transmission. The WTRU may determine whether to use 3-state HARQ for a scheduled sidelink grant based on one or more sidelink data characteristics. The one or more sidelink data characteristics may include one or more of a PDB value, a QoS, a logical channel, a location of slot(s), a physical sidelink feedback channel (PSFCH) location, a downlink control information (DCI), and/or a PUCCH transmission time. The PDB value may be associated with the sidelink data that will be transmitted within the scheduled sidelink grant. The QoS may be associated with data that may be transmitted within the scheduled sidelink grant. The logical channel may be associated with the data that may be transmitted within the scheduled sidelink grant. The location of the slot(s) may be associated with a sidelink data transmission within the COT. The PSFCH location may be associated with a sidelink data transmission within the acquired COT. The DCI may include scheduling of the sidelink grant indicating whether to use 3-state HARQ or 2-state HARQ. The PUCCH transmission time may be configured for reporting sidelink HARQ feedback to the gNB. For example, there may be a PDB threshold. If PDB is below the threshold 2-state HARQ may be used. If PDB is equal to or greater than the threshold 3-state HARQ may be used. A QoS identifier may be associated with 2-states HARQ or 3-state HARQ. A logical channels ID may be associated with 2-state HARQ or 3-state HARQ.

An SL grant assignment may be received at a WTRU from a network. For example, the SL grant assignment may be received in a DCI. A sidelink assignment index may be used. For, example an indication of the SL assignment index may be received from the network (e.g., in the DCI). The WTRU may determine a value of a counter sidelink assignment indicator and/or a total sidelink assignment indicator, for example in a subsequent DCI. The SL grant assignment may include one or more predefined values for one or more sidelink (SL) data characteristics. For example, a predefined value may include one or more of a PDB, QoS, logical channel value. The predefined value may be associated with 2-state HARQ and/or 3-state HARQ.

The WTRU may generate one or more HARQ sub-codebooks (e.g., first and second). The one or more HARQ sub-codebooks may include SL HARQ information for a HARQ mode. For example, a first HARQ sub-codebook may include SL HARQ information for a first HARQ mode and/or a second HARQ sub-codebook may include SL HARQ information for a second HARQ mode. The first HARQ mode may include a 2-state HARQ mode. The 2-states may include ACK/NACK . . . . The second HARQ mode may include a 3-state HARQ mode. The 3-states may include delayed HARQ, ACK, and NACK

The WTRU may determine whether to use (e.g., enable) the first HARQ mode and/or the second HARQ mode, for example based on the one or more predefined values for the one or more SL data characteristics being met for the SL grant assignment. The WTRU may determine to add 1 bit to a HARQ codebook, for example if the WTRU determines that 3 state HARQ is not enabled. The WTRU may determine to add 2 bits to the HARQ codebook, for example if the WTRU determines that 3 state HARQ is enabled.

The WTRU may transmit the SL HARQ information based on whether the one or more predefined values for the one or more SL data characteristic is met for the SL grant assignment. For example, the WTRU may transmit the SL HARQ information in the first HARQ mode based on the one or more predefined values for the one or more SL data characteristics being met for the SL grant assignment. Additionally, or alternatively, the WTRU may transmit the SL HARQ information in the second HARQ mode based on the one or more predefined values for the one or more SL data characteristics not being met for the SL grant assignment.

The WTRU may determine whether to use 3-state HARQ for a scheduled sidelink grant based on a PDB value of the sidelink data that, for example may be transmitted within the scheduled sidelink grant. The WTRU may use 3-state HARQ to report the sidelink feedback to the gNB, for example if the PDB of the sidelink data transmission to be transmitted using the scheduled sidelink has a PDB value belonging to the configured set of PDB values for which 3-state HARQ may be used. The WTRU may (e.g., otherwise) use 2-state HARQ. The WTRU may use the smallest PDB value of the multiplexed data to determine whether to use 3-state or 2-state HARQ, for example if the WTRU determines to multiplex sidelink data with different PDB values within the same sidelink grant. For example, if the WTRU is multiplexing two logical channels in the same grant, where the first logical channel is associated with a first PDB (e.g., has PDB1) and the second logical channel is associated with a second PDB (e.g., has PDB2) (e.g., PDB1<PDB2), the WTRU may use PDB1 to determine if 3-state HARQ is enabled or not. If the smaller PDB value (e.g., PDB1) is within the set of PDB values for which 3-state HARQ may be used for example, the WTRU may use 3-state HARQ to report the sidelink feedback to the gNB.

The WTRU may determine whether to use 3-state HARQ for a scheduled sidelink grant based on the QoS of the data that, for example may be transmitted within the scheduled sidelink grant. The WTRU uses 3-state HARQ, for example if the QoS flow of the sidelink data transmission to be transmitted using the scheduled sidelink grant has a QoS flow corresponding to the set of QoS flows configured to use 3-state HARQ. If the WTRU determines to multiplex data with multiple QoS flows within the same sidelink grant, the WTRU may use 3-state HARQ, for example if (e.g., only) one or more (e.g., all) QoS flows to be multiplexed are within the set of configured QoS flows to support 3-state HARQ.

The WTRU may determine whether to use 3-state HARQ for a scheduled sidelink grant based on a logical channel of the data that, for example may be transmitted within the scheduled sidelink grant. If the logical channel ID and/or the logical channel group of the sidelink data transmission to be transmitted within the scheduled sidelink grant corresponds to a logical channel(s) and/or logical channel groups configured to use 3-state HARQ for example, the WTRU may use 3-state HARQ.

The WTRU may determine whether to use 3-state HARQ for a scheduled sidelink grant based on the location of the slot(s) for sidelink data transmission within the COT. The WTRU may be configured with one or more slots within a COT on which, for example 3-state HARQ may be used. The WTRU may determine the slots based on a pre-configuration, and/or when receiving the sidelink grant and/or COT configuration.

The WTRU may determine whether to use 3-state HARQ for a scheduled sidelink grant based on the physical sidelink feedback channel (PSFCH) location corresponding to sidelink data transmission being within the acquired COT. For example, the transmitter WTRU may initiate a COT and/or may indicate to the gNB the COT structure (e.g., set of slots for sidelink data transmission and set of slots for PSFCH transmissions). Additionally, or alternatively, the gNB may determine (e.g., know) the location of PSFCHs, for example based on a resource pool configuration. The Tx WTRU and/or the gNB may determine (e.g., be aware of) the location of the PSFCHs within the COT. The WTRU may (e.g., then) enable the 3-state HARQ for the sidelink grant, for example if the sidelink data transmission has a corresponding PSFCH outside the COT.

The WTRU may determine whether to use 3-state HARQ for a scheduled sidelink grant based on an indication in the DCI scheduling the sidelink grant. The indication in the DCI scheduling the SL grant may indicate whether to use 3-state HARQ or 2-state HARQ. The DCI may include a bitfield. The bitfield may indicate the enabling of 3-state HARQ feedback. Additionally, or alternatively, the DCI format used to schedule the sidelink grant may indicate the enablement of 3-state HARQ. For example, a given DCI format may be used (e.g., only) for 3-state HARQ when scheduling a sidelink grant is triggered.

The WTRU may determine whether to use 3-state HARQ for a scheduled sidelink grant based on the PUCCH transmission time configured to report sidelink HARQ feedback to the gNB. The WTRU may be configured with multiple values of transmission PUCCH timing (e.g., semi-statically configured) and/or (e.g., some) values when indicated to be used for PUCCH transmission to report sidelink feedback to the gNB, the WTRU may use 3-state HARQ. The PUCCH transmission time associated with 3-state HARQ may be indicated to the WTRU and/or fixed in the specification. For example, 3-state HARQ or 2-state HARQ may be used by the WTRU for a PUCCH transmission time (e.g., k1, k2, and/or k3). For PUCCH in k1 for example, the WTRU may use 2-state HARQ. For PUCCH in k2 and/or k3 for example, the WTRU may use 3-state HARQ. The configuration may indicate a PUCCH transmission timing threshold, for example above which the WTRU may enable 3-state HARQ.

A sidelink assignment index may be used. The WTRU may determine (e.g., assume) that the value of a counter sidelink assignment indicator and/or the total sidelink assignment indicator will be increased by two in the next DCI format scheduling sidelink grant, for example if the WTRU enables 3-state HARQ for sidelink grant and/or the WTRU is configured with a dynamic HARQ-ACK codebook (e.g., Type 2 HARQ codebook). The WTRU may determine (e.g., expect) the total sidelink assignment indicator will count sidelink grants using 3-state HARQ with a first value (e.g., 2) and sidelink grants using 2-state HARQ with a second value (e.g., 1), for example if the WTRU is configured with a semi-static HARQ codebook (e.g., Type 3 HARQ codebook).

A WTRU may report a HARQ codebook to a gNB. The WTRU may report the sidelink HARQ feedback using one or more (e.g., 2) bits for a sidelink grant with 3-state HARQ and/or one or more (e.g., 1) bit for a sidelink grant with 2-state HARQ enabled, for example when reporting the HARQ feedback to the gNB using a HARQ codebook. The WTRU may include (e.g., mix) 3-state HARQ and 2-state HARQ within the same HARQ codebook. The WTRU may order the HARQ feedback for different sidelink grants, for example based on the order of the DCI scheduling the sidelink grants. The WTRU may be configured to append the HARQ feedback for sidelink grant using 3-state HARQ, for example at the end of the HARQ codebook. The WTRU may utilize HARQ feedback for sidelink grants with 2-state HARQ and/or may append the HARQ feedback for sidelink grants with 3-state HARQ (e.g., after 2-state HARQ feedback).

The HARQ codebook may include one or more (e.g., two) sub-codebooks. For example, the WTRU may generate two sub-codebooks. A sub-codebook may include HARQ feedback for SL transmission(s), for example according to a HARQ mode (e.g., second HARQ mode). The second HARQ mode may include a 3-state HARQ mode. The 3-states may include ACK, NACK, and a delayed HARQ. The sub-codebook may include HARQ feedback for SL transmission(s), for example according to a HARQ mode (e.g., first HARQ mode). The first HARQ mode may include a 2-state HARQ mode. The 3-states may include ACK and NACK.

The WTRU may determine whether a second HARQ mode is enabled, for example for a subset of SL transmissions. The subset of SL transmissions may include SL transmissions for which HARQ feedback is reported, for example to a gNB. The WTRU may determine a size of a (e.g., first and/or second) HARQ sub-codebook. The size of the (e.g., first and/or second) HARQ sub-codebook may be based on a number of a subset of SL transmission(s), for example for which NACK has been received and/or no response has been received. The number of the subset may be based on (e.g., include) a number of SL grants. The HARQ sub-codebook (e.g., first and/or second) may include an order of bits. The order of bits may be based on an order of the number of sidelink grants in the subset of the one or more sidelink transmissions. The (e.g., second) HARQ sub-codebook may include HARQ feedback for the subset of SL transmissions, for example according to a HARQ mode (e.g., the second HARQ mode). The (e.g., second) HARQ mode may include a 3-state HARQ mode. The 3-states may include delayed HARQ and/or ACK/NACK.

The WTRU may determine one or more UL resources for transmission of the HARQ sub-codebook(s). For example, the WTRU may determine whether to transmit the first HARQ sub-codebook and the second HARQ sub-codebook in a same uplink (UL) resource or in different UL resources, for example based on an indication from a network. The indication from the network may be included in a DCI. The WTRU may receive a transmission from another WTRU. The transmission may be a PSFCH transmission. The transmission may include HARQ feedback. The WTRU may report (e.g., transmit) HARQ feedback to a network.

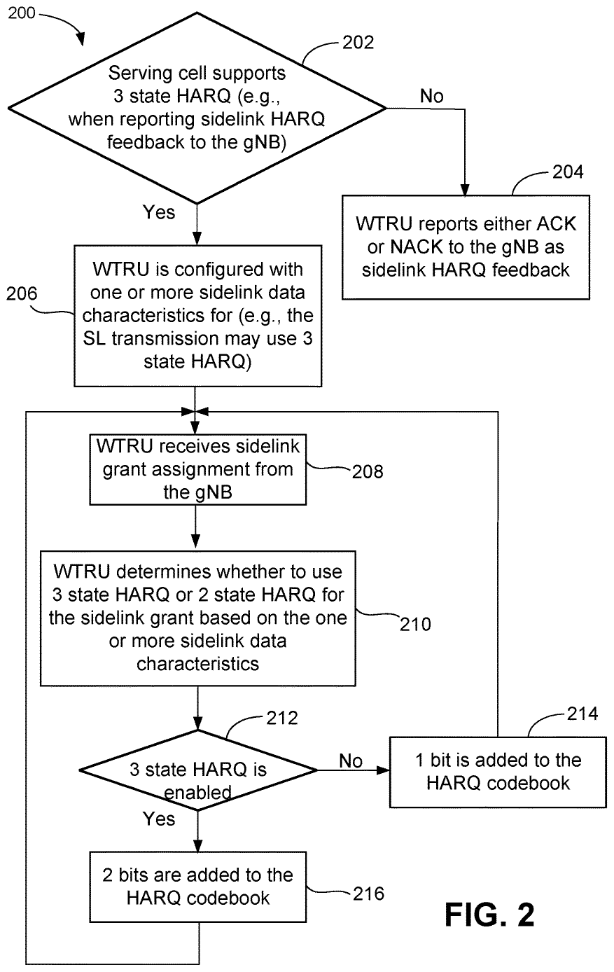

FIG. 2 is an flowchart 200 of an example procedure to enable 3-state HARQ. At 202, a WTRU and/or a serving cell may support 3 state HARQ, for example when reporting sidelink HARQ to a gNB. For example, the WTRU and/or serving cell may determine whether 3 state HARQ is supported. The WTRU may be configured using RRC signaling, for example if 3-state HARQ is supported by the serving cell when reporting sidelink HARQ feedback to the gNB (e.g., in sidelink unlicensed spectrum). At 204, the WTRU may (e.g., always) report either ACK or NACK for a scheduled sidelink grant, for example if the serving cell does not support 3-state HARQ. At 206, the WTRU may be configured with one or more sidelink data characteristics, for example if the WTRU and/or the serving cell supports 3-state HARQ. The WTRU may be configured with one or more of a set of PDB values, a QoS, a logical channel, a logical channel group (LCG), sidelink data slots, and/or PSFCH of sidelink data slots. The sidelink data transmission may use 3-state HARQ.

At 208, the WTRU may receive a sidelink grant assignment, for example from the gNB. For example, a sidelink assignment index may be used. An indication of the SL assignment index may be received from the network (e.g., in the DCI). The WTRU may determine a value of a counter sidelink assignment indicator and/or a total sidelink assignment indicator, for example in a subsequent DCI. The SL grant assignment may include one or more predefined values for one or more sidelink (SL) data characteristics. The WTRU may determine (e.g., assume) that the value of a counter sidelink assignment indicator and/or the total sidelink assignment indicator will be increased by two in the next DCI format scheduling sidelink grant, for example if the WTRU enables 3-state HARQ for sidelink grant and/or the WTRU is configured with a dynamic HARQ-ACK codebook (e.g., Type 2 HARQ codebook). The WTRU may determine (e.g., expect) the total sidelink assignment indicator will count sidelink grants using 3-state HARQ with a first value (e.g., 2) and sidelink grants using 2-state HARQ with a second value (e.g., 1), for example if the WTRU is configured with a semi-static HARQ codebook (e.g., Type 3 HARQ codebook).

At 210, the WTRU may determine whether to use a 3-state HARQ reporting or not (e.g., to use a 2-state HARQ reporting), for example, for a scheduled sidelink grant. The WTRU may determine whether to use 3-state HARQ or 2-state HARQ for the SL grant based on the one or more SL data characteristics. For example, the WTRU may determine to use the 3-state HARQ reporting if one or more of conditions are met. The one or more conditions may include one or more of a PDB value of the sidelink transmission corresponding to a preconfigured value for which 3-state HARQ can be supported, a QoS flow of the sidelink transmission corresponding to a preconfigured packet quality indicator (PQI) for which 3-state HARQ can be supported, an LCH of the sidelink transmission corresponding to a preconfigured LCH for which 3-state HARQ can be supported, the slots for sidelink data transmission within the acquired COT are configured with 3-state HARQ, the PSFCH location corresponding to sidelink data transmission is not within the acquired COT, the PUCCH transmission time K1 indicates a value before the PSFCH reception time, and/or the DCI scheduling the grant has a flag with a value that indicates enabling of 3-state HARQ.

At 212, the WTRU may determine whether 3 state HARQ is enabled. At 214, the WTRU may determine to add 1 bit to a HARQ codebook, for example if the WTRU determines that 3 state HARQ is not enabled. At 216, the WTRU may determine to add 2 bits to the HARQ codebook, for example if the WTRU determines that 3 state HARQ is enabled. The procedure may return to 208, for example after 214 and/or 216.

The WTRU may report a sidelink HARQ codebook to the gNB using one or more (e.g., 2) bits for sidelink grant associated with 3-state HARQ, and one or more (e.g., 1) bits for sidelink grant associated with 2-state HARQ (e.g., 2 states HARQ). The same (e.g., one) HARQ codebook may have 3-state HARQ and 2-state HARQ.

A HARQ sub-codebook for delayed HARQ feedback may be used. A WTRU may be configured to determine, for a (e.g., each) scheduled grant, whether to use 2-state HARQ or 3-state HARQ. The WTRU may (e.g., then) group the HARQ feedback of a group of sidelink grants within a (e.g., one) HARQ codebook. A HARQ codebook may include a set of bits that, for example may indicate HARQ feedback for a group of sidelink grants. The WTRU may determine the group of sidelink grants for which the HARQ feedback should be reported in the same HARQ codebook, for example if at least the transmission time of the HARQ feedback is the same for the sidelink grants. For example, the WTRU may be configured at slot n1 with a first sidelink grant and/or the HARQ feedback may be (e.g., required to be) transmitted at slot k1. Additionally, or alternatively, at slot n2 the WTRU may be configured with a second sidelink grant and/or with HARQ feedback transmission at slot k1. The WTRU may report the HARQ feedback of the first and second grants in a slot (e.g., slot k1), for example using the same HARQ codebook.

HARQ feedback of sidelink grants may be combined and reported to the gNB. For example, some sidelink grants may use 2-state HARQ and other sidelink grants may use 3-states HARQ. The WTRU (e.g., Tx WTRU) may transmit on sidelink channels using the sidelink grant, and/or may (e.g., then) receive sidelink HARQ feedback for the sidelink grant from the Rx WTRU. The sidelink HARQ feedback may be combined and reported to the gNB using the same HARQ codebook.

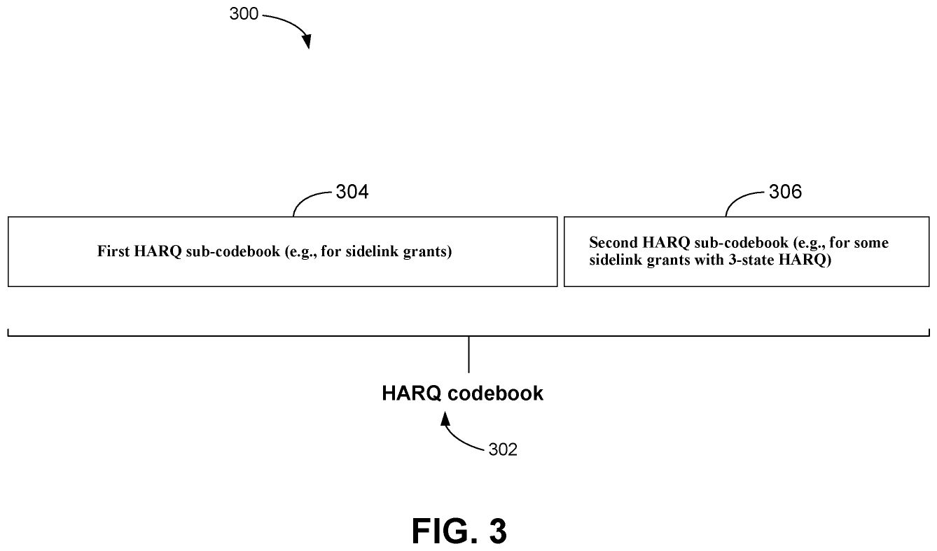

One or more (e.g., two) HARQ sub-codebooks may be used. The WTRU may be configured to report one or more (e.g., two) HARQ sub-codebooks when 3-state HARQ is enabled for at least one of the sidelink grants, for example as shown in FIG. 3. FIG. 3 illustrates an example 300 of a HARQ codebook 302 including two HARQ sub-codebooks 304, 306.

For example, if at least one sidelink grant is using 3-state HARQ, the WTRU may report two HARQ sub-codebooks 304, 306. The WTRU may report, in the first sub-codebook 304, 2-state HARQ for one or more of (e.g., all) the scheduled sidelink grants, regardless of whether 3-state HARQ is enabled for a sidelink grant or not. The WTRU may report 1 bit (e.g., ACK or NACK) per scheduled grant in the first HARQ-ACK sub-codebook 304 and/or order the ACK/NACK bits within the first HARQ-ACK sub-codebook 304, for example using the order of the DCI scheduling the sidelink grant. If 3-state HARQ is enabled for a sidelink grant, the WTRU may report, in the first HARQ sub-codebook 304, ACK or NACK for that sidelink grant. For example, the WTRU may report ACK if the sidelink grant was successfully decoded (e.g., PSFCH indicates ACK for sidelink grant), or NACK if the sidelink grant was not successfully decoded. For example, PSFCH may indicate NACK for sidelink grant and/or the PSFCH corresponding to the sidelink grant may not be received prior to the transmission time of the first HARQ sub-codebook 304 (e.g., delayed HARQ). The WTRU may report an ACK value for that sidelink grant, for example if a sidelink grant uses 3-state HARQ and the corresponding PSFCH is received before the transmission time of the first HARQ sub-codebook 304, and/or if the PSFCH indicates ACK.

Table 1 indicates example values that may be reported by the WTRU for different cases:

TABLE 1
First HARQ sub-codebook reporting values for different cases

| | HARQ mode for a sidelink grant | |
|---|---|---|
| Sidelink feedback | 2 states HARQ | 3 states HARQ |
| PSFCH received and | WTRU reports ACK | WTRU reports ACK |
| indicates ACK | | |
| PSFCH received and | WTRU reports NACK | WTRU reports NACK |
| indicates NACK | | |
| PSFCH is not received | WTRU reports NACK | WTRU reports NACK |

For example, the WTRU may be configured with one or more (e.g., 4) sidelink grants, with one or more (e.g., 3) first sidelink grants using 2-states HARQ and one or more (e.g., the fourth) sidelink grants using 3-state HARQ. The WTRU may report, in the first HARQ sub-codebook 304, ACK or NACK for one or more of (e.g., all) the sidelink grants, including the fourth sidelink grant. If the WTRU did not receive the PSFCH corresponding to the fourth grant for example, the WTRU may report NACK for the fourth grant in the first HARQ sub-codebook 304. The WTRU may report NACK for the fourth grant in the first HARQ sub-codebook, for example if the WTRU receives the PSFCH corresponding to the fourth grant and the PSFCH indicates NACK. If the WTRU receives the PSFCH corresponding to the fourth grant and the PSFCH indicates ACK for example, the WTRU may report ACK for the fourth grant in the first HARQ sub-codebook 304.

The WTRU may use the second HARQ sub-codebook 306 (e.g., only) for sidelink grants using 3-state HARQ. If one or more of (e.g., all) the sidelink grants to be reported in a HARQ codebook are with 2-state HARQ for example, then the WTRU may report (e.g., only) the first HARQ sub-codebook 304. The WTRU may report the first and the second HARQ sub-codebook 304, 306, for example if some sidelink grants to be reported in a HARQ codebook 302 are with 3-state HARQ. For a sidelink grant using 3-state HARQ the WTRU may transmit additional information in the second HARQ sub-codebook 306, for example if the corresponding PSFCH was not received before the transmission time of the first HARQ sub-codebook 304 and/or if the PSFCH is received before the transmission time of the first HARQ sub-codebook 304 and the PSFCH indicates NACK.

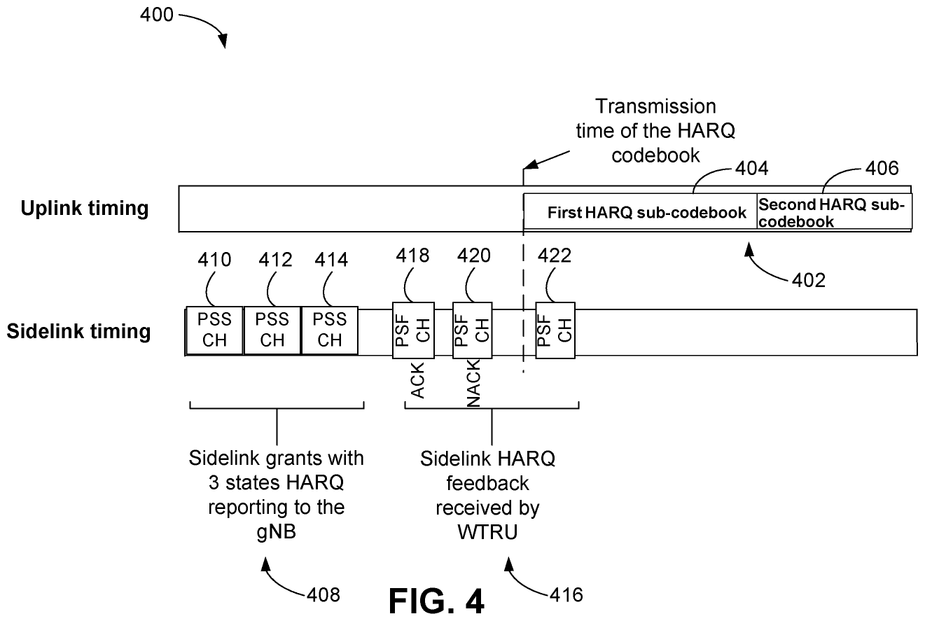

FIG. 4 illustrates an example 400 of a WTRU receiving a PSFCH after the transmission time of a first HARQ codebook 402. As shown in FIG. 4, there may be 3 sidelink transmissions with 3-state HARQ. One of the PSFCHs may be received after the transmission time of the first HARQ codebook 402. The WTRU may report, in a first sub-codebook 404, 2-state HARQ for one or more of (e.g., all) the scheduled sidelink grants, regardless of whether 3-state HARQ is enabled for a sidelink grant or not. The WTRU may use a second HARQ sub-codebook 406 (e.g., only) for sidelink grants using 3-state HARQ.

If the PSFCH is not received for example, the WTRU may report a value of 1 in the second HARQ sub-codebook 406. If the PSFCH is received and indicates NACK for example, the WTRU may report a value of 0 in the second HARQ sub-codebook 406. If, for one or more (e.g., all) sidelink grants with 3-state HARQ, the PSFCHs are received and indicating ACK values, the WTRU may report (e.g., only) the first HARQ sub-codebook 404. For example, if the WTRU determines to report (e.g., is reporting) HARQ information for sidelink grants with (e.g., only) 3-state HARQ and/or the PSFCHs corresponding to the sidelink grants are received before the transmission time of the HARQ codebook 402 and/or all the PSFCHs indicates ACK values, the WTRU may report (e.g., only) the first HARQ sub-codebook 404, and/or may not transmit the second HARQ sub-codebook 406.

Sidelink timing may include one or more SL grants reported at 408. For example, the one or more SL grants may include SL grants with 3-states. The SL grants may be reported to a network, for example a gNB. The one or more SL grants may be reported in one or more PSSCH transmissions 410, 412, 414. The WTRU may receive SL HARQ feedback at 416. The SL HARQ feedback may be received in one or more PSFCH transmissions 418, 420, 422. For example, ACK may be received in a PSFCH transmission 418. Additionally, or alternatively, NACK may be received in a PSFCH transmission 420.

Table 2 indicates example values that may be reported by the WTRU for different cases:

TABLE 2
Second HARQ sub-codebook reporting values for different cases

HARQ mode for a sidelink grant

| Sidelink feedback | 2 states HARQ | 3 states HARQ |
|---|---|---|
| PSFCH received and | Nothing to report | Nothing to report |
| indicates ACK | | |
| PSFCH received and | Nothing to report | “0” is reported |
| indicates NACK | | |
| PSFCH is not received | Nothing to report | “1” is reported |

The WTRU may order the HARQ information within the second HARQ sub-codebook 406, for example based on the reception time of the DCI scheduling the sidelink grant. The WTRU may be configured with one or more (e.g., 5) sidelink grants with HARQ feedback to be reported at the same HARQ transmission time. The WTRU may report, to the gNB, the HARQ feedback of the one or more (e.g., 5) sidelink grants using the same HARQ codebook. The WTRU may determine that one or more (e.g., the first, second and third) sidelink grants are using 3-state HARQ and/or one or more (e.g., the fourth and fifth) sidelink grants are using 2-state HARQ. The WTRU may transmit the sidelink grants and/or monitor the corresponding PSFCHs transmissions to be transmitted by the Rx WTRU. The Rx WTRU may refer to different receiver WTRUs or the same Rx WTRU (e.g., if all the sidelink grants are delegated to the same Rx WTRU).

If the WTRU is configured with 5 sidelink grants for example, the WTRU may receive, from a Rx WTRU, a PSFCH for a first sidelink grant indicating ACK and/or a PSFCH for a second sidelink grant indicating NACK. The WTRU may not receive PSFCH for a third sidelink grant in some examples. The WTRU may receive, for example from a Rx WTRU, a PSFCH for a fourth grant indicating ACK and/or a PSFCH for a fifth grant indicating NACK. The WTRU may (e.g., therefore) report two HARQ sub-codebooks 404, 406. A first HARQ sub-codebook 404 may include (ACK, NACK, NACK, ACK, NACK). The second HARQ sub-codebook 406 may contain (0,1). For example, (e.g., both) of the WTRU and/or the gNB may determine (e.g., know) which sidelink grants will use 3-state HARQ feedback, and/or which sidelink grants will use 2-state HARQ feedback. For the sidelink grants with 3-state HARQ feedback for example, if the first HARQ sub-codebook 404 indicates a NACK, the second HARQ sub-codebook 406 may carry additional information. The order of the additional information within the second HARQ sub-codebook 406 may be based on the order of reception of the sidelink grant. The HARQ codebook 402 to be reported to the gNB may (e.g., therefore) include (ACK, NACK, NACK, ACK, NACK, 0, 1).

For example if the WTRU is configured with 5 sidelink grants, the WTRU may receive, from a Rx WTRU, a PSFCH for a first sidelink grant indicating NACK, and/or a PSFCH for a second sidelink grant indicating NACK. The WTRU may not receive PSFCH for the third sidelink grant in some examples. The WTRU may receive, from a Rx WTRU, a PSFCH for a fourth grant indicating ACK and a PSFCH for a fifth grant indicating NACK. The WTRU may (e.g., therefore) report two HARQ sub-codebooks 404, 406. A first HARQ sub-codebook 404 may include (NACK, NACK, NACK, ACK, NACK). The second HARQ sub-codebook 406 may include (0,0,1). The HARQ codebook 402 to be reported to the gNB may (e.g., therefore) include (NACK, NACK, NACK, ACK, NACK, 0, 0, 1).

If the WTRU is configured with 5 sidelink grants for example, the WTRU may receive, from a Rx WTRU, a PSFCH for a first sidelink grant indicating ACK, and/or a PSFCH for a second sidelink grant indicating ACK, and/or a PSFCH for a third sidelink grant indicating ACK. The WTRU may receive, from a Rx WTRU for example, a PSFCH for a fourth grant indicating ACK and a PSFCH for a fifth grant indicating NACK. The WTRU may (e.g., therefore) report a (e.g., one) HARQ sub-codebook 404, 406. The HARQ sub-codebook 404, 406 may include (e.g., only) the first HARQ codebook 404, for example containing (ACK, ACK, ACK, ACK, NACK). The HARQ codebook 402 to be reported to the gNB may (e.g., therefore) include (ACK, ACK, ACK, ACK, NACK).

The WTRU may determine the size of the HARQ sub-codebooks 404, 406. The WTRU may determine the size of the HARQ codebook 402 to be reported to the gNB based on a multi-step (e.g., two-step) approach. The WTRU may determine the size of the first HARQ sub-codebook 404 (e.g., in a first step). The WTRU may determine the size HARQ codebook 402 to determine the size of the first HARQ sub-codebook 404, for example if the HARQ codebook 402 is equal to the first HARQ sub-codebook 404. For example, the WTRU may determine the size of a HARQ codebook using a counter and/or a (e.g., total) sidelink assignment index. The WTRU may determine whether a second HARQ sub-codebook 406 will be used or not as described herein (e.g., as a second step). As described herein, the WTRU may use the second HARQ sub-codebook 406, for example if for at least one sidelink grant using 3-state HARQ the corresponding PSFCH indicates NACK and/or the corresponding PSFCH is not received before the transmission time of the first HARQ sub-codebook 404. If the WTRU is using a second HARQ sub-codebook 406 for example, the size of the second HARQ sub-codebook 406 may be equal to the number of sidelink grants using 3-state HARQ minus the number of PSFCHs corresponding to sidelink grants using 3-state HARQ and indicating ACK values and received before the transmission time of the first HARQ sub-codebook 404. For example, the WTRU may be configured with one or more (e.g., 5) sidelink grants with 3-state HARQ. The WTRU may receive (e.g., only) one PSFCH indicating ACK before the transmission time of the first HARQ-ACK sub-codebook 404. The size of the second HARQ sub-codebook 406 may (e.g., therefore) be 4. The size of the HARQ codebook 402 may be equal to the sum of the size of the first HARQ sub-codebook 404 and the second HARQ sub-codebook 406.

The WTRU may be configured with the (e.g., exact) size of the second HARQ sub-codebook 406, for example regardless of the number of sidelink grants with 3-state HARQ for which PSFCH indicates NACK and/or for which PSFCH is not received. The WTRU may add padding bits to the determined number and/or report the second HARQ sub-codebook 406 with the configured size, for example if the WTRU determines the number of sidelink grants with 3-state HARQ for which PSFCH indicates NACK and/or for which PSFCH is not received is below the configured size of the second HARQ sub-codebook 406. If the WTRU has more bits to report in the second HARQ sub-codebook 406 for example, the WTRU may report up to the configured size and may not report the remaining information bits.

The WTRU may be configured with a maximum size of the second HARQ sub-codebook 406. The WTRU may (e.g., therefore) not exceed the maximum configured size when reporting the second HARQ sub-codebook 406 in some examples. If the WTRU has more bits to report in the second HARQ sub-codebook 406 for example, the WTRU may report up to the configured maximum number and may not report the remaining information bits.

The WTRU may use an uplink resource to transmit the HARQ sub-codebooks 404, 406. The WTRU may be configured to transmit the one or more (e.g., two) HARQ sub-codebooks 404, 406 described herein using the same uplink resource. The WTRU may receive an indication in the DCI, for example to transmit the two HARQ sub-codebooks 404, 406 using the same uplink resource. For example the resource may include a PUCCH resource and/or a PUSCH resource. The WTRU may determine the PUCCH resource based on the HARQ codebook 402 size that is the sum of first and second HARQ sub-codebook 404, 406, for example if the WTRU determines to transmit (e.g., is transmitting) the HARQ sub-codebooks 404, 406 using a PUCCH resource. If the WTRU determines to transmit (e.g., is transmitting) the HARQ sub-codebooks 404, 406 using a PUSCH resource for example, the WTRU may determine the number of resources to use from PUSCH for HARQ codebook 402 based on the size of the first and second HARQ sub-codebooks 404, 406.

The WTRU may be configured to transmit the one or more (e.g., two) HARQ sub-codebooks 404, 406 using separate uplink resources. For example, the first HARQ sub-codebook 404 may be transmitted using a first PUCCH resource and the second HARQ sub-codebook 406 may be transmitted using a second PUCCH resource. The first HARQ sub-codebook 404 may be transmitted using a PUCCH resource and the second HARQ sub-codebook 406 may be transmitted using a PUSCH resource. The first HARQ sub-codebook 404 may be transmitted using a PUSCH resource and the second HARQ sub-codebook 406 may be transmitted using a PUCCH resource. The first HARQ sub-codebook 404 may be transmitted using a first PUSCH resource and the second HARQ sub-codebook 406 may be transmitted using a second PUSCH resource.

The WTRU may determine the uplink resource to use to transmit the first and second resources based on the determined size of the of the HARQ sub-codebooks 404, 406. The WTRU may determine to use separate uplink resources for the first and second HARQ sub-codebooks 404, 406, for example if the sum of the sizes of the HARQ sub-codebooks is greater than or equal to a (e.g., configured) threshold. The threshold may be indicated using the scheduling of the sidelink grants and/or alternatively may be pre-configured using RRC signaling or fixed in the specification.

The WTRU may be configured with an uplink resource to transmit the second HARQ sub-codebook 406, for example after transmitting the first HARQ sub-codebook 404. For example, the WTRU may report (e.g., only) the first HARQ sub-codebook 404 using the uplink resource configured for the HARQ codebook 402. After reporting the first HARQ sub-codebook 404 for example, the WTRU may monitor a DCI that triggers and/or allocates an uplink resource for the second HARQ sub-codebook 406 transmission.

The WTRU may transmit HARQ information for a sidelink grant previously acknowledged as delayed HARQ. The WTRU, after reporting a delayed HARQ value to the gNB, may monitor, in sidelink channels for example, PSFCH corresponding to the sidelink data for which delayed HARQ was reported to the gNB. The WTRU may receive the PSFCH with either an ACK or NACK value. For example, the WTRU may report the PSFCH information received after reporting the delayed HARQ value to the gNB. The WTRU may receive a DCI. The DCI may trigger the transmission of the previously delayed HARQ feedback. The DCI may trigger one or multiple HARQ feedback that were previously delayed (e.g., reported as delayed HARQ). The triggering DCI may indicate the uplink resource and/or the transmission time on which the HARQ feedback should be reported.

The WTRU may be configured to append the HARQ feedback of previously-delayed HARQ into a subsequent HARQ codebook. The subsequent HARQ codebook may include a HARQ codebook configured for transmission after X milliseconds (ms) of the transmission time of the HARQ codebook on which delayed HARQ information was reported. The DCI triggering the HARQ transmission of previously-delayed HARQ may indicate the value of X. The WTRU may be configured using RRC with a set of one or more X values, and/or the DCI may indicate one of the values. For example, the WTRU may report a delayed HARQ value using a first HARQ codebook. The WTRU may (e.g., then) receive a PSFCH corresponding to the sidelink grant that was acknowledged as delayed HARQ. The WTRU may monitor a DCI indicating a transmission opportunity for the delayed HARQ. The WTRU may receive the DCI indicating the X ms after which the delayed HARQ feedback should be transmitted. For example, the WTRU may be configured to transmit (e.g., exactly) X ms after the transmission time of the HARQ codebook on which delayed HARQ information was reported. In other examples, the WTRU may be configured to transmit no later than X ms after the transmission time of the HARQ codebook on which delayed HARQ information was reported (e.g., the transmission may happen before X ms but should not exceed X ms).

The WTRU may be configured to report the previously-acknowledged HARQ feedback as delayed HARQ values, for example using a one-shot HARQ feedback. The WTRU may be configured with a selective one-shot HARQ feedback. The WTRU may report HARQ feedback for (e.g., only) the sidelink grants previously acknowledged as delayed HARQ, for example for (e.g., selective) one-shot HARQ feedback. The selective one-shot HARQ feedback may be triggered using a pre-configured DCI format and/or using a bitfield in the DCI.

The WTRU may be configured to not transmit the HARQ feedback for sidelink grants already acknowledged as delayed HARQ and/or instead transmit a scheduling request and/or buffer status report (BSR). After reporting delayed HARQ values for one or more sidelink grants for example, the WTRU may monitor PSFCHs at later occasions. When the WTRU receives the feedback for example, the WTRU may determine whether additional sidelinks are needed. The WTRU may (e.g., then) use a scheduling request and/or uplink grant to transmit BSR to request additional resources for sidelink transmission.

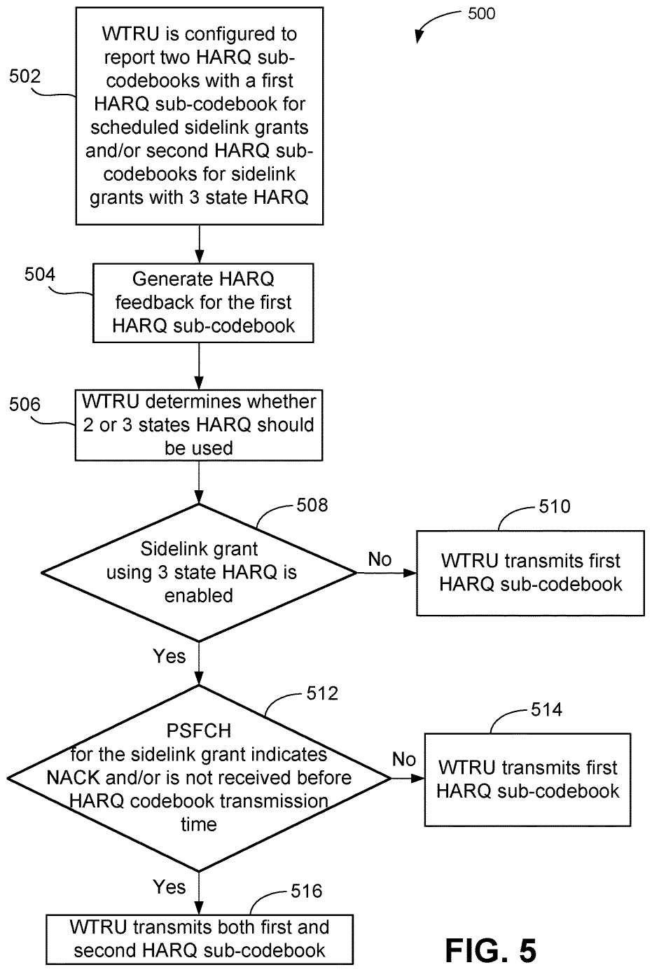

FIG. 5 is an example flowchart 500 of a WTRU process determining whether to transmit two HARQ sub-codebooks. At 502, the WTRU may be configured to report one or more (e.g., two) HARQ sub-codebooks. The first HARQ sub-codebook may carry 2-state HARQ feedback for one or more (e.g., all) the scheduled sidelink grants. The second HARQ sub-codebook may carry additional information for (e.g., only) sidelink grants with 3-state HARQ enabled. At 504, the WTRU may generate feedback for the (e.g., first) HARQ sub-codebook. At 506, the WTRU may determine, for example for a sidelink grant, whether to use 3-state HARQ-ACK or 2-state HARQ-ACK. The WTRU may determine the size of the first HARQ-ACK sub-codebook, for example using a (e.g., total) sidelink assignment index. The sidelink assignment index may be in and/or associated with a DCI. The sidelink assignment index may indicate a (e.g., total) size of a HARQ codebook and/or sub-codebook.

At 508, the WTRU may determine whether a sidelink grant using a 3 state HARQ is enabled. At 510, the WTRU may transmit the first HARQ sub-codebook, for example if a sidelink grant using a 3 state HARQ is not enabled. The WTRU may determine the size of the second HARQ sub-codebook based on the number of sidelink grants configured with 3-state HARQ and the corresponding PSFCH information received before the HARQ codebook transmission time. At 512, the WTRU may determine whether PSFCH for the sidelink grant indicates NACK and/or is not received before HARQ codebook transmission time, for example if a sidelink grant using a 3 state HARQ is enabled. For a sidelink with 3-state HARQ, if the corresponding sidelink PSFCH indicates ACK is received from the Rx WTRU before the transmission time of the HARQ codebook for example, the WTRU may not report any information in the second HARQ sub-codebook. At 514, the WTRU may transmit the (e.g., first) HARQ sub-codebook, for example if PSFCH for the sidelink grant does not indicate NACK (e.g., indicated ACK) and/or is received before HARQ codebook transmission time. If the corresponding sidelink PSFCH indicates NACK is received from the Rx WTRU before the transmission time of the HARQ codebook for example, the WTRU may report a value of 0 in the second HARQ sub-codebook. If the corresponding sidelink PSFCH is not received from the Rx WTRU before the transmission time of the HARQ codebook for example, the WTRU may report a value of 1 in the second HARQ sub-codebook. The order of the bits in the second HARQ sub-codebook may follow the order of the scheduled sidelink grants.

At 516, the WTRU may determine to transmit and/or transmit (e.g., both) the first and/or second HARQ sub-codebook, for example if PSFCH for the sidelink grant indicates NACK and/or is not received before HARQ codebook transmission time. The WTRU may determine whether to report the two HARQ sub-codebooks in one or more same uplink resources and/or in one or more separate resources, for example based on the gNB indication in the DCI. The WTRU may transmit the two HARQ sub-codebooks to the gNB. The WTRU may receive the sidelink HARQ feedback from the Rx WTRU after being delayed. The WTRU may be configured to report HARQ feedback for previously delayed HARQ feedback, for example using a DCI that triggers the previously-delayed HARQ feedback and/or by appending the delayed HARQ feedback to the HARQ codebook that may be transmitted after X ms from the initial transmission of the HARQ codebook.

The processes and instrumentalities described herein may apply in any combination, may apply to other wireless technologies, and for other services.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed is:

1-20. (canceled)

21. A method implemented in a wireless transmit/receive unit (WTRU), the method comprising:
generating a first hybrid automatic repeat request (HARQ) sub-codebook, wherein the first HARQ sub-codebook comprises HARQ feedback for one or more sidelink transmissions according to a first HARQ mode;
determining that a second HARQ mode is enabled for a subset of the one or more sidelink transmissions;
determining a size of a second HARQ sub-codebook, wherein the second HARQ sub-codebook comprises HARQ feedback for the subset of the one or more sidelink transmissions according to the second HARQ mode;
generating the second HARQ sub-codebook; and
transmitting the first HARQ sub-codebook and the second HARQ sub-codebook to a network.

22. The method of claim 21, wherein the second HARQ mode comprises a 3-state HARQ mode and wherein the first HARQ mode comprises a 2-state HARQ mode.

23. The method of claim 22, wherein 3-state HARQ mode comprises a delayed HARQ and the 2-state HARQ mode comprises acknowledgment/non-acknowledgement (ACK/NACK).

24. The method of claim 21, wherein determining the size of the second HARQ sub-codebook comprises determining a number of the subset of the one or more sidelink transmissions for which a non-acknowledgement (NACK) has been received or no response has been received.

25. The method of claim 21, further comprising determining whether to transmit the first HARQ sub-codebook and the second HARQ sub-codebook in a same uplink (UL) resource or in different UL resources.

26. The method of claim 25, wherein whether to transmit the first HARQ sub-codebook and the second HARQ sub-codebook in a same uplink (UL) resource or in different UL resources is determined based on an indication in a downlink control information (DCI).

27. The method of claim 21, further comprising determining a size of the first HARQ sub-codebook.

28. The method of claim 21, further comprising:
receiving a physical sidelink feedback channel (PSFCH) transmission from a second WTRU, wherein the PSFCH transmission comprises HARQ feedback; and
reporting the HARQ feedback to the network.

29. The method of claim 21, wherein determining the size of the second HARQ sub-codebook is based on a number of sidelink grants in the subset of the one or more sidelink transmissions.

30. The method of claim 29, wherein an order of bits comprised in the second HARQ sub-codebook is based on an order of the number of sidelink grants in the subset of the one or more sidelink transmissions.

31. A wireless transmit/receive unit (WTRU) comprising a processor, the processor configured to:
generate a first hybrid automatic repeat request (HARQ) sub-codebook, wherein the first HARQ sub-codebook comprises HARQ feedback for one or more sidelink transmissions according to a first HARQ mode;
determine that a second HARQ mode is enabled for a subset of the one or more sidelink transmissions;
determine a size of a second HARQ sub-codebook, wherein the second HARQ sub-codebook comprises HARQ feedback for the subset of the one or more sidelink transmissions according to the second HARQ mode;
generate the second HARQ sub-codebook; and
transmit the first HARQ sub-codebook and the second HARQ sub-codebook to a network.

32. The WTRU of claim 31, wherein the second HARQ mode comprises a 3-state HARQ mode and wherein the first HARQ mode comprises a 2-state HARQ mode.

33. The WTRU of claim 32, wherein 3-state HARQ mode comprises a delayed HARQ and the 2-state HARQ mode comprises acknowledgment/non-acknowledgement (ACK/NACK).

34. The WTRU of claim 31, wherein the processor being configured to determine the size of the second HARQ sub-codebook comprises the processor being configured to determine a number of the subset of the one or more sidelink transmissions for which a non-acknowledgement (NACK) has been received or no response has been received.

35. The WTRU of claim 31, wherein the processor is further configured to determine whether to transmit the first HARQ sub-codebook and the second HARQ sub-codebook in a same uplink (UL) resource or in different UL resources.

36. The WTRU of claim 35, wherein the processor is configured to determine whether to transmit the first HARQ sub-codebook and the second HARQ sub-codebook in a same uplink (UL) resource or in different UL resources based on an indication in a downlink control information (DCI).

37. The WTRU of claim 31, wherein the processor is further configured to determine a size of the first HARQ sub-codebook.

38. The WTRU of claim 31, wherein the processor is further configured to:
receive a physical sidelink feedback channel (PSFCH) transmission from a second WTRU, wherein the PSFCH transmission comprises HARQ feedback; and
report the HARQ feedback to the network.

39. The WTRU of claim 31, wherein the processor configured to determine the size of the second HARQ sub-codebook is based on a number of sidelink grants in the subset of the one or more sidelink transmissions.

40. The WTRU of claim 39, wherein an order of bits comprised in the second HARQ sub-codebook is based on an order of the number of sidelink grants in the subset of the one or more sidelink transmissions.
